(19) United States
(12) Patent Application Publication
(10) Pub. No.: US 2026/0356073 A1
(43) Pub. Date: Nov. 12, 2026

(54) LIGHTWEIGHT FIRE-RESISTANT PLATE-LIKE COMPOSITE MATERIAL

(71) Applicant: HOLLAND COMPOSITES B.V., Lelystad (NL)

(72) Inventors: Sven Erik JANSSEN, Lelystad (NL); Pieterjan DWARSHUIS, Lelystad (NL)

(21) Appl. No.: 19/131,318

(22) PCT Filed: Nov. 20, 2023
(86) PCT No.: PCT/NL2023/050607

§ 371 Date: May 20, 2025

(30) Foreign Application Priority Data
Nov. 20, 2022 (NL) 2033573
Nov. 20, 2022 (NL) 2033574

(51) Int. Cl. B32B 3/12; B32B 3/06; B32B 5/02; B32B 5/18; B32B 5/24; B32B 27/28

(52) U.S. Cl. CPC B32B 3/12; B32B 3/06; B32B 5/024; B32B 5/18; B32B 5/245; B32B 27/28; B32B 2250/40; B32B 2255/02; B32B 2266/0264; B32B 2307/3065; B32B 2307/72; B32B 2607/00

(57) ABSTRACT

The present invention relates to a lightweight composite material suitable for use in the manufacture of fire-resistant insulation panels, comprising a lightweight core layer sandwiched between two composite fibre-reinforced resin layers. In particular, but not exclusively, the present invention relates to a composite material suitable for use as architectural insulation panels comprising a first layer comprising polyfuranyl resin and glass fibres, a core layer comprising an insulation material, and a second layer comprising a cured polyfuranyl resin and glass fibres. The composite material may comprise one or more additional outer coating and structural layers on one or both sides of the composite material.

The present invention relates to a lightweight composite material suitable for use in the manufacture of fire-resistant insulation panels, comprising a lightweight core layer sandwiched between two composite fibre-reinforced resin layers. In particular, but not exclusively, the present invention relates to a composite material suitable for use as architectural insulation panels comprising a first layer comprising polyfuranyl resin and glass fibres, a core layer comprising an insulation material, and a second layer comprising a cured polyfuranyl resin and glass fibres. The composite material may comprise one or more additional outer coating and structural layers on one or both sides of the composite material.

### BACKGROUND OF THE INVENTION

Composite materials, in particular shaped articles such as panels are used in various applications, for instance as elements of furniture (e.g. table tops, benches, seating) or interior finishing material in buildings. Such composite materials usually comprise a binder material and a solid filler material, material that offers structural integrity and/or insulation value, as well as external layers facing the environment.

Specifically for furniture, interior finishing materials, and building insulation applications, the composites need to be durably resistant to various wearing conditions, including physical abrasion, fluctuations in humidity and temperature, exposure to UV and other radiation, as well as resistance to chemicals and (micro)biological growth.

Traditional composite materials used in furniture and interior finishing have typically relied on medium-density or high-density wooden boards. However, these materials difficult to shape, tend to warp in damp conditions and are combustible. Furthermore, durably resistant to the different wearing conditions, including physical abrasion, variations in the materials have a high density, which in turn limits their use to applications and constructions that can bear the high weight. In the realm of wall insulation, composite materials have been developed using fiber-reinforced concrete or gypsum. Nevertheless, these materials present their own set of issues, as they are difficult to shape or affix due to the low mechanical strength of the composites in general. This is usually addressed by adding a tie coat or adhesive layer between the outer shell, and the core material. Furthermore, the thusfar employed materials have a high density, whichin combination with the low mechanical strength requires comparatively thick walls, which in turn limits their use to applications and constructions that can bear the high weight. A further issue with these materials is the leaching of highly corrosive salts.

In order to reduce weight and/or to improve mechanical performance, composites based on plywood sheet materials and/or wood chips have been developed. Plywood usually consists of sheets of wood that are glued or cemented together, using for instance thermosetting polyurethane or thermosetting unsaturated polyester and styrene binders, or epoxy resin and amino curing agent binders. U.S. Pat. No. 6,044,604 for instance discloses a composite roofing board having a foam core of polyisocyanurate, polyurethane or mixtures thereof between a gypsum board and a facer layer. U.S. Pat. No. 5,718,096 discloses using recycled materials and glass fibres in composite panel elements for use in building structures. U.S. Pat. No. 6,322,731 discloses the use of rice husks, wheat husks and sawdust in forming constructions panels.

However, while these materials show better mechanical properties as compared to fibre re-inforced concrete, they tend to emit organic compounds, such as for example formaldehyde. For environmental reasons, there is a trend to use materials that emit low levels of organic volatiles.

U.S. Pat. No. 6,158,176 discloses a sound absorbing panel comprising a core of mineral wool bounded by flat front and rear surfaces comprising fibre-glass. The sound absorbing panel was disclosed as being prepared by spraying a mineral wool core with an adhesive, then contacting the adhesive layer with fibre-glass sheets, followed by three days of curing. The adhesive used was a styrene-butadiene copolymer in hexane/acetone solvent, the solution having a viscosity of 700 centipoise, and a solids content of 28%. This adhesive was disclosed as having a high volatility and high solids content, so the adhesive did not migrate beyond its initial site of contact and rapidly achieves a tacky state.

US 2020199022 A1 discloses thermal and/or acoustic insulation products based on mineral wool, notably glass wool or rock wool, and a formaldehyde-free organic binder, wherein the binder contains furan resin and 5-60 wt. % of reducing sugar and/or non-reducing sugar. This document discloses insulation products prepared by sizing of glass fibres directly with the aqueous binder after production of the fibres, and subsequently, insulation products are formed by curing the impregnated non-woven fabrics by aqueous solutions comprising furan resin and sugar, followed by oven-hardening at 220 °C.

While this leads to products with a high tensile strength, the amount of resin binder is significant, since it is used throughout the entire product. Also, by the addition of the sizing binder agent, the insulation efficacy may be reduced since fibres are glued together during the curing stage, and hence comprise less voids, and getting denser.

Oriented Strand Boards (OSBs) are a type of engineered wood alternative formed by adding adhesives to wood strands (flakes) and then compressing layers of wood strands (flakes) in specific orientations. Oriented strand board is typically manufactured in wide mats from cross-oriented layers of thin, rectangular wooden strips compressed and bonded together with wax and synthetic resin adhesives (approximately 95% wood; 5% adhesive, wax and The adhesive resins types used include: urea-formaldehyde (OSB type 1, non-structural, waterproof); isocyanate-based glue (or PMDI polymethylene diphenyl diisocyanate based) in inner regions with melamine-urea-formaldehyde or phenol formaldehyde resin glues at surface (OSB type 2, structural, water resistant on face); phenol formaldehyde resin throughout (OSB) types 3 and 4, structural, for use in damp and outside environments). OSB is a material with mechanical properties that make it particularly suitable for load-bearing applications in construction, but whose density and external appearance typically preclude its use in furniture and as an interior finishing material.

However, these composites are still relatively flammable, which limits their use as interior finishing materials and use in furniture, especially in the commercial sector where compliance with fire regulations is a legal requirement. For interior finishing materials, the concept of “flame spread” is used, which specifies the rate at which a flame will spread along the surface of a material. The best-known flame-spread test is the “tunnel test” which has been adopted as AST test StandardE-84.

The lowest flame-spread rate (0 to 25) is permitted for areas where fire hazard is most severe, as in vertical exit-ways of buildings without sprinkler systems that are used for public assembly. Materials which rate 26 to 75 are permitted in areas of intermediate fire hazard severity, such as corridors providing exit-ways in commercial and industrial structures. Materials, rated at from 76 to 200 are permitted in rooms of most dwelling places, except hospital rooms and the like.

Typical flame-spread ratings for untreated plywood grades range from 75 to 200. Typical flame-spread ratings for untreated Oriented Strand Boards(OSBs) range from 75 to 175. To improve the flame-spread ratings, these composite materials are often treated with fire-retardant chemicals. Plywood can be pressure-impregnated with fire-retardant salts to inhibit combustion. Plywood may be impregnated with fire-retardant chemicals in accordance with American Wood Protection As-sociation Standard U1 to have a flame spread of 25 or less when subjected to a 30-minute test. Fire-retardant treatment involves proprietary chemical formulations that generally reduce the structural properties of plywood.

To provide “lighter” (less dense) composite materials, sandwich-structured composites have been developed. A sandwich-structured composite is a special class of composite materials that is fabricated by attaching two thin, stiff skin layers onto a thicker, lightweight core. The core material is normally low strength material, but its higher thickness provides the sandwich composite with high bending stiffness with overall low density.

Suitable core materials include natural materials such as cork and balsawood, corrugated cardboard and paper honeycomb, as well as man-made open-and closed-cell-structured foams like polyether sulfone polyvinylchloride, polyurethane, polyethylene or polystyrene foams.

In some applications, the honeycomb structure may be filled with other foams to provide additional strength.

Laminates of glass or carbon fibre-reinforced thermoplastics or mainly thermoset polymers (unsaturated polyesters, epoxies, etc.) are widely used as skin materials. The core is typically bonded to the skins with an adhesive.

WO2016/016621 discloses layered composite structures comprising a cellular core faced with skin layers, each skin layer comprising a fibre layer and an outermost veneer layer. The application discloses a panel comprising two bio-resin impregnated natural fibre mats on wither side of a paper honeycomb core, with a veneer outer layer.

Similarly, WO2016/063011 discloses laminated composite material. The composite material comprises a first skin layer comprising a network of inorganic fibres and a core layer comprising a network of natural fibres at least partially impregnated with a resin-based binder component. The application discloses forming a composite panel suitable for an airline galley cart by combining a core of hemp fibres, aramid (thickness 5 mm, cell diameter about 3 mm) and acid catalysed PFA resin with skin layers of woven basalt fibres, and then pressing and heating at 180 °C for 150 seconds.

WO2016/067048 concerns a process for manufacturing laminated composites. The laminated composites comprise a honeycomb between skins of natural fibre mats. The process entails contacting a paper honeycomb core with natural fibre mats pre-impregnated with a bio-resin, followed by a single heating and moulding step.

GB2485525A finally concerns composite panels prepared from furan resin-impregnated fibre mats and methods for their manufacture. This application discloses placing a paper honeycomb core between two impregnated natural resin mats, wherein two different resins are employed to impregnate the materials. This is again cumbersome process, requiring two separate resin applications, and a carefully concerted curing process.

Accordingly, there remains a need to provide lightweight materials that offer high strength and low flammability, ideally based essentially or entirely on sustainable resources, and a single resin formulation.

Applicants have now surprisingly found that environmentally stable, resistant to humidity and/or rot, and highly insulating composite materials that can be prepared from a material comprising an insulation core material, such as mineral wool, glass wool or, thermoplastic polymeric foam materials; and a fibrous exterior material impregnated with an aqueous polyfuranyl binder and curing agent prepreg system. Furthermore, the materials can advantageously be sourced from recycling materials that otherwise has few other uses.

### BRIEF SUMMARY OF THE DISCLOSURE

Applicants have made a surprising discovery: composite materials that are environmentally stable, resistant to humidity and rot, and have excellent insulation properties, can be manufactured. These composites are made from materials that may include an insulation core, such as mineral wool, glass wool, thermoplastic polymeric foam, paper, cardboard or paper/cardboard honeycomb. Additionally, they incorporate a fibrous exterior layer (prepreg) that is impregnated with an aqueous polyfuranyl binder and a curing agent, applied through an impregnation process. Furthermore, these materials have the added advantage of being sourced from recycled substances, which would otherwise have limited applications Accordingly, in a first aspect, the present invention relates to a lightweight, fire-resistant plate-like composite material for use in construction products, furniture applications, building elements, insulation, façade and/or roof cladding material, comprising: a first layer comprising a cross-linked polyfuranyl resin and inorganic fibre fabric, at least one core layer having a lower density than the first layer; and a second layer comprising a crosslinked polyfuranyl resin and inorganic fibre fabric.

Preferably, the mineral fibre fabric may comprise a mineral wool, such as glass fibre.

Further, the at least one core layer may function as an insulation layer comprising an insulating core material. Further, the core layer may be arranged in an intermediate position between the first layer and the second layer.

Accordingly, in a further aspect, the present invention relates to a lightweight, fire-resistant plate-like composite material for use in construction products, building elements or furniture applications, comprising: a first layer comprising a crosslinked polyfuranyl resin and a mineral fibre fabric; at least one core layer with a cellular structure; and a second layer comprising a crosslinked polyfuranyl resin and a mineral fibre fabric.

In a further aspect, the present invention relates to a composite material for use as insulation and façade and/or roof cladding material, comprising: a first layer comprising a crosslinked polyfuranyl resin and a mineral fibres ; at least an insulation layer comprising an insulating core material (2); and a second layer comprising a crosslinked polyfuranyl resin and mineral fibres, wherein the second layer is arranged in an intermediate position between the first layer and the second layer, and is adhered to the first and second layer.

The core layer may comprise a mineral wool such as glass fibre, and/or a thermoplastic foam material, or may have a cellular structure made of paper, cardboard and/or thermoplastic foam material, wherein the thermoplastic foam material is selected from a foamed polyurethane, a foamed polystyrene, and/or a foamed polyester, more preferably foamed polyethylene terephthalate.

Preferably, the mineral wool may be selected from glass wool, stone wool, and/or ceramic fibre wool, more preferably from glass wool, or glass fiber (fiberglass).

Preferably, the core layer may have a cellular structure, such as a honeycomb cellular structure, the honeycomb structure comprising internal walls arranged perpendicular to the planes of the first and second layers.

Preferably, the at least one core layer may have a cellular structure made of paper or cardboard honeycomb, positioned in between a first and a second layers, where both the first and the second layers are made of glass fibre impregnated with polyfuranyl resin.

Preferably, the at least one core layer may have a corrugated structure and material selected from corrugated fibreboard, paper, cardboard honeycomb, or a polymeric foam material, more preferably a thermoplastic foam material.

Preferably, the core layer of the lightweight fire-resistant plate-like composite material may comprise a thermoplastic foam material, wherein the foam material is a polyester based material and wherein the polyester is virgin or post-consumer polyethylene terephthalate, or a mixture of the two and wherein the foam material is characterized by elongated cells, which have an aspect ratio larger than 1.5, and by a density according to ISO 845 of lower than 150kg/m3 , preferably lower than 80 kg/m3, and by a thermal conductivity of lower than 0.032 W/mK measured according to ISO 12677. In a further embodiment, the thermoplastic foam material may further comprise additionally polymer blends that are present in the thermoplastic foam material layer in an amount of not more than 40 wt % and wherein the additional polymer blends are selected from the group of polyalkylene terephthalates, polylactic acid, polycarbonate, polyolefins, polyacrylates, polyamides, thermoplastic elastomers, core-shell polymers, liquid crystal polymers (LCP), or a mixture thereof.

Preferably, the inorganic fiber fabrics used in both the first and second layers can be chosen from a range of materials, such as glass fibers, rock fibers, or carbon fibers. More preferably, the inorganic fiber fabric selected is glass fiber (fiberglass).

Preferably, the lightweight fire-resistant plate-like composite material may further comprise a structural layer or sheet.

Preferably, the lightweight fire-resistant plate-like composite material additionally may comprise an additional outer coating layer on at least one side of the composite material, preferably an additional outer coating layer on at least two sides of the composite material, even more preferably an additional coating layer fully enveloping the first, second layers and at least one core layer.

In a second aspect, the present invention relates to an article of sustainable and recyclable fire-resistant furniture, a building exterior or interior panel, or an exterior or interior finishing material comprising the composite material according to the invention.

In a further aspect, the present invention relates to the intermediate prepreg sheets; optionally deposited onto a transport medium, such as a backing sheet.

In a further aspect, the present invention relates a method for the manufacture of a prepreg sheet for use in formation of lightweight, fire-resistant plate-like composite material according to the first aspect of the invention, the method comprising: Impregnating a sheet comprising woven mineral fibres(fabric woven from mineral fibers) with a liquid polyfuranyl resin composition; to provide an impregnated sheet; subjecting the impregnated sheet to conditions inducing gelation of the polyfuranyl resin composition, thereby forming a prepreg sheet; and optionally depositing a prepreg sheet onto a transport medium, preferably a backing sheet and optionally removing the prepreg sheet on the backing sheet; and optionally, rolling up the prepreg sheet on the transport medium, to form a reel of a rolled up prepreg sheet.

In yet a further aspect, the present invention relates to the prepreg sheet, or prepreg sheet reel obtainable from the method.

A further aspect of the present invention relates to a process for manufacturing a composite material, wherein the process comprises the following steps: providing an insulation core layer made of mineral wool; coating/contacting the insulation core layer on its first surface with a mixture comprising polyfuranyl resin and glass fibre to provide a first outer layer comprising polyfuranyl resin and glass fibres ; coating/contacting the insulation core layer with a mixture comprising polyfuranyl resin and glass fibre on its second surface to provide a second outer layer comprising polyfuranyl resin and glass fibres; heating the composite material comprising the three layers under pressure to consolidate and cure the composite material.

Preferably, the insulation core layer comprises mineral wool, more preferably glass wool. Glass wool is an insulating material made from fibres of glass arranged using a binder into a texture similar to wool. The process traps many small pockets of air between the glass, and these small air pockets result in high thermal insulation properties.

In another aspect, the present disclosure relates to: a method for the manufacture of a composite panel, comprising: Impregnating a sheet comprising woven mineral fibres with a liquid polyfuranyl resin composition, to provide an impregnated sheet; subjecting the impregnated sheet to conditions inducing gelation of the polyfuranyl resin composition, thereby forming a prepreg sheet; optionally depositing a prepreg sheet onto a transport medium, preferably a backing sheet and optionally removing the prepreg sheet on/from the backing sheet; arranging at least a core layer between two prepreg sheets, such that such that the top surface of the second sheet opposes the bottom surface of the first sheet, to form a sandwich structure; and subjecting the sandwich structure to conditions that allow the gelled polyfuranyl resin composition to cure essentially fully, preferably including heating the sandwich structure to a temperature and for a time period that results in crosslinking and chain growth of the polyfuranyl resin composition.

Preferably, the method for the manufacture of a composite panel comprises an optional step: adding a further layer of a solid material, prior to subjecting the sandwich structure to conditions that allow the gelled polyfuranyl resin composition to cure, the solid material being preferably a plywood composite material adjacent to a composite prepreg layer prior to step e), to obtain an enforced composite material.

Preferably, the method for the manufacture of a composite panel comprises a further step of applying pressure to the composite panel during curing, wherein the step of applying pressure involves the use of a vacuum table, a plate press, a bag press or a nip rolling apparatus.

In yet another aspect, the present disclosure relates to a panel comprising a core layer formed by the lightweight fire-resistant plate-like composite material according to the first aspect of the present invention, comprising: an integrally formed, outwardly-extending attachment flange defined by the entire thickness of the panel and proximal to the outward surface around two around at least two adjacent side edges of the panel, for receiving elongate fastener elements through the entire thickness of the panel and into an underlying support member; two spaced-apart elements formed on and extending along respective adjacent sides of the attachment flange remote from the surface and defining a groove therebetween; a complementary tongue projecting outwardly from and extending along respective adjacent sides of the panel for being received in a groove of a complementary adjacent structural element; wherein the attachment flange resides intermediate the groove and the surface, for permitting the groove to receive the tongue of the complementary structural element therein.

In a further aspect, the present invention relates to a cladding assembly comprising the lightweight, fire-resistant plate-like composite material for a wall or roof of a building, comprising a panel-securing element comprising a first flange, a second flange, and a web securing the first flange with respect to the second flange in a spaced-apart configuration, wherein the first flange is secured to the frame element to attach the panel-securing element to the frame element; a plurality of insulation panels, each of the plurality of insulation panels having opposed faces defining a thickness therebetween and a first edge abutting or facing against the web of the panel-securing element with the second flange of the panel-securing element disposed over a peripheral portion of one of the opposed faces, wherein a spacing between the first and second flanges of the panel-securing element is at least as large as the thickness of the insulation panel; wherein each of the plurality of insulation panels comprises a multilayer facing material forming at least one of the opposed faces; and wherein the facing material includes an overhanging portion extending beyond a second edge of each of the insulation panels to secure each of the insulation panels adjacent to one another during installation and to form an air, thermal and moisture barrier between each of the adjacent insulation panels.

Preferably, the panel comprising the core layer formed by the lightweight fire-resistant plate-like composite material further comprises first and second alternating interlocking tongues and alternating interlocking grooves comprise dove tail members.

In another aspect, the present invention relates to a panel comprising a core layer formed by the lightweight fire-resistant plate-like composite material in accordance with the first aspect of the present invention, further comprising means for attachment of the panel to an underlying support by fastener elements through the attachment flange.

In another aspect, the present invention relates to use of the lightweight fire-resistant plate-like composite material, as a building material, preferably for use as sound and/or heat insultation building material.

Preferably, the panel is essentially rectangular or square shaped.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Embodiments of the invention are further described hereinafter with reference to the accompanying drawings, in which:

FIG. 1 illustrates an aspect of the subject matter in accordance with one embodiment. FIG. 1 is a perspective view of a preferred embodiment of the plate-like composite material according to one embodiment of the invention, showing a peel-away section of the core honeycomb, a corner enforcement element, a glass fibre thermoset composite layer, and a top layer attached to the composite.

FIG. 2 illustrates an aspect of the subject matter in accordance with one embodiment. FIG. 2 is a top view of a preferred embodiment of the invention, showing the internal core layer comprising a honeycomb card-board core and a side element.

FIG. 3 illustrates an aspect of the subject matter in accordance with one embodiment. FIG. 3 is a cross-sectional view of a preferred embodiment of the invention, showing the composition of a preferred embodiment of a material according to the invention.

FIG. 4 illustrates an aspect of the subject matter in accordance with one embodiment. FIG. 4 is a perspective view of a composite panel according to an embodiment of the invention (4A), and of two conventional comparative panels (4B and 4C). The Figure shows an exploded view, a side elevation and a cross-sectional view of each panel.

FIG. 5 illustrates an aspect of the subject matter in accordance with one embodiment. FIG. 5 is a side elevation showing attachment of a composite panel through the core adjacent the tongue of a preferred embodiment;

FIG. 6 illustrates an aspect of the subject matter in accordance with one embodiment. FIG. 6 is a side elevation showing attachment of a composite panel through the core adjacent the groove of a preferred embodiment;

FIG. 7 illustrates an aspect of the subject matter in accordance with one embodiment. FIG. 7 is a side elevation showing attachment of a composite panel through the core adjacent the groove of a preferred embodiment.

### DETAILED DESCRIPTION

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as con-templating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The term “plate-like composite material” refers herein to a type of composite material that is formed or molded into a flat, thin shape resembling a plate.

The term “binder composition” as used herein means all ingredients applied to the matter to be bound and/or present on the matter to be bound, notably prior to curing, (other than the matter and any moisture contained within the matter) including cellulose hydrolysate sugars, any inorganic ammonium salt crosslinker and any additives, and possibly solvents (including water).

The term “binder” is used herein to designate a thermoset binder resin obtained from the “binder composition”.

The term “cured” means that the components of the binder composition have been subjected to conditions that lead to chemical change, such as covalent bonding, hydrogen bonding and chemical crosslinking, which may increase the cured product's durability and solvent resistance, and result in thermoset material.

The term “dry weight of the binder composition” as used herein means the weight of all components of the binder composition other than any water that is present, whether in the form of liquid water or in the form of water of crystallization.

The term “crosslinker” as used herein comprises compounds that are capable of reacting with the carbohydrate components of the cellulose hydrolysate to form ramifications or reticulations of the polyfuranyl compounds.

The terms “glass fibre fabric”, or “glass fibre mat” or “fiberglass fabric”, or simply “fiberglass” or glassfibre” are used herein interchangeably.

The term “prepreg” or “pre-impregnated”, generally refers herein to a combination of a reinforcement fiber and a resin matrix, where the resin is already applied and partially cured to a specific stage before the material is used for manufacturing.

Applicants have found that the lightweight composite material and the panels of the invention solve the problem of fire retardancy in a lightweight composite construction useful for building application, with a minimum of additional fire retardants or fire protection materials due to the inherent high fire retardancy of the subject materials.

Applicants have also found that the panels of the invention solve the problem of providing high acoustic insulation properties in a lightweight composite construction useful for building application, in particular as panels for insulation, or as structural building elements.

The composite material according to the invention was also found to be inherently resistant to attack by microbes and insects and thus does not require expensive chemical treatments. Also, the material is resistant to degradation from exposure to ultraviolet light as well as damp and/or freezing conditions.

Thus, the panels of the present invention, made of a lightweight composite material or having a core made of a lightweight composite material, have enhanced fire retardancy, superior acoustic insulation, and inherent resistance to microbes, insects, and environmental degradation like ultraviolet exposure and extreme temperatures, making them highly suitable for diverse building applications.

A first aspect of the present invention relates, a lightweight, fire-resistant plate-like composite material for use in construction products, furniture applications, building elements, insulation, façade and/or roof cladding material, comprising: a. a first layer comprising a crosslinked polyfuranyl resin and inorganic fibre fabric, b. at least one core layer having a lower density than the first layer; and c. a second layer comprising a crosslinked polyfuranyl resin and inorganic fibre fabric. Further, the at least one core layer may be an insulation layer comprising an insulating core material, and wherein the at least one core layer may be arranged in an intermediate position between the first layer and the second layer. Preferably, the inorganic fibre fabric may comprise a mineral wool, such as glass fibre.

In a preferred embodiment, the present invention relates to a composite material for use as insulation and façade and/or roof cladding material, comprising: a first layer comprising a crosslinked polyfuranyl resin and a mineral fibres ; at least a core insulation layer comprising an insulating core material; and a second layer comprising a crosslinked polyfuranyl resin and mineral fibres, wherein the core insulation layer is arranged in an intermediate position between the first layer and the second layer, and is adhered to the first and second layer. Preferably, the mineral fibres may comprise a mineral wool, such as glass fibres.

In a preferred embodiment, the present invention relates to a lightweight, fire-resistant plate-like composite material for use in construction products, building elements or furniture applications, comprising: a first layer comprising a crosslinked polyfuranyl resin and a mineral fibre fabric; at least one core layer with a cellular structure; and a second layer comprising a crosslinked polyfuranyl resin and a mineral fibre fabric. Preferably, the mineral fibre fabric may comprise a mineral wool, such as glass fibre.

The composite material comprises a first layer and a second layer comprising a polyfuranyl resin as main binder component.

In another aspect, the present invention relates to a method for the manufacture of a prepreg sheet for use in formation of lightweight, fire-resistant plate-like composite material, comprising:
a. Impregnating a sheet comprising woven mineral fibres with a liquid polyfuranyl resin composition; to provide an impregnated sheet;
b. subjecting the impregnated sheet to conditions inducing gelation of the polyfuranyl resin composition, thereby forming a prepreg sheet; and
c. optionally depositing a prepreg sheet onto a transport medium, preferably a backing sheet and optionally removing the prepreg sheet on the backing sheet; and
d. optionally, rolling up the prepreg sheet on the transport medium, to form a reel of a rolled up prepreg sheet.

The materials according to the invention are advantageously prepared using an impregnation and gelation process, also known as a “prepreg process”, wherein resin-impregnated and gelled fiberglass sheets are used in the formation of prepreg sheets, which are then employed to form the composite.

In this process, an inorganic fibre fabric, in particular fiberglass fabric, is impregnated with a thermosetting polyfuranyl resin composition, which is then partially cured to induce gelation. The impregnated fabric may then be sheared to form so called prepreg sheets.

In order to enhance the adhesion of the resin to the fiberglass, often a coupling or sizing agent, such as a silane, is coated onto the surface of the fiberglass fabric, or individual fibres prior to impregnation. One of the particularly desirable characteristics of the present resin-impregnated fiberglass sheets is that the resin-impregnation covers the fibres and can be partially cured to a non-tacky state wherein the sheets can be handled for the lamination process, and roll storage.

This is often referred to as a B-stage, a cure state which allows the sheets to be sufficiently self-supporting to be laid up as a laminate, but not advanced enough in the state of cure that they are rigid or non-flowable when heated, and they can be further cured to a final cure with heat and pressure to form a laminate structure as is well known in the art.

Prepreg materials or sheets, may be directly employed, or removably placed on a polymeric backing sheet, which allows preparing larger coils of prepreg material, whereby each winding is divided by the backing sheet. The thus obtained gelled material may hence be employed directly in line, but usually are coiled, preferably supported by a backing sheet to avoid tacking of the individual layers. As prepreg sheets retain part of their reactivity, sheets and/or coils are usually stored under controlled and suitable conditions.

For use, the prepreg sheets are then laid up with core materials, and laminated by subjecting them to heat and pressure, to fully cure the laid-up laminate with the core material, thereby forming a hardened surface layer and a bond with the core materials.

As indicated above, the lamination process normally includes the lamination of one or more core layers to provide necessary functionality.

Advantageously, sides and edges may be formed, thereby fully encapsulating the lightweight, fire-resistant plate-like core layer, and giving it various shapes useful for the later use.

In a preferred embodiment, the resin-impregnated sheet is formed by providing a coil of the fabric, e.g. fibreglass (glass wool or glass fibre) material, which is unwound from the coil and continuously passed through a tank containing an aqueous solution or dispersion of the polyfuranyl resin, and then the coated or impregnated material is passed through a treater tower wherein heat is applied to drive off part of the water, and to the resin material is partially cured by initiating crosslinking. The fabric may be treated in two or more passes. The thus obtained gelled material may directly be employed, or it may be coiled, preferably supported by a backing sheet to avoid tacking of the individual layers.

After partial curing, the material is uncoiled and can be either directly applied in line or cut into sheets of the desired length, referred to as prepreg sheets. These sheets can then be used in the lamination process as previously described.

In forming laminate structures which include resin impregnated glass fibres and core layers, it was found that the polyfuranyl resins showed a surprisingly high adhesion to the core materials, and good penetration, in particular porous materials, thereby obviating the need for tack or adhesive layers, even when applied a thin layers thicknesses. Also, defects that can occur because of poor adhesion to glass fibre were minimized, while at the same time being extremely low in volatile organic compounds.

Applicants found surprisingly that the prepreg materials according to the invention allowed a thorough bond to the core layer, thereby also increasing the strength and cohesion of the core layer significantly, even at a prepreg thickness in the range of from 0.1 to 0.8 cm.

Without wishing to be bound by any particular theory, it is believed that the polyfuranyl resins are particularly effective in wetting and permeating the surrounding layers before curing, thereby forming an infused composite material with significantly enhanced adhesion.

According to the present invention, a method and resultant article are provided which showed an optimal adhesion of the fibrous fabric impregnated with a resin to the interior layer materials, in particular optimal adhesion of the impregnated resin layer to the core layers laminated thereto, even at a low layer thickness.

The inorganic fibres of the first and second inorganic fibre fabric layers may advantageously be both mineral fibres. Suitable mineral fibres include glass fibres such as e-glass fibres, carbon fibre or fibres based on naturally-sourced minerals. More preferably, the inorganic fibres of the first and second inorganic fibre fabric layers are glass fibres.

Suitable naturally-sourced mineral fibres are basalt fibres, for example. Basalt, or other rock-based fibres are of interest in view of their low environmental impact. Basalt fibres are typically formed by crushing quarried or mined basalt, washing the crushed basalt and heating to a melting temperature of above 1400 °C. The molten rock is then extruded through fine nozzles to form filaments of basalt fibre. Such fibres are considered to have superior mechanical properties compared with regular glass fibres, and yet be considerably cheaper and more environmentally friendly to produce than advanced glass and carbon fibres.

Preferably, the inorganic fibres of the first and/or second inorganic fibre fabric layer satisfy one or more of the following properties of a density in the range of from 2.4 to 2.9 g/cm3 , a tensile strength in the range of from 4 to 5 GPa; and/or an elastic modulus of from 90 to 120 GPa.

Preferably, before bonding, the first and/or second inorganic fibre fabric layer has a smaller thickness than the one or more core layers. Before bonding, the thickness of the first and/or second inorganic fibre fabric layer is preferably at least 0.1 mm, and preferably at most 2 mm. The thickness of the one or more core layers depends on the desired use.

By the term “glass fibre fabric”, or “glass fibre mat” or “fiberglass” is meant one or more layers of unidirectional rovings that are assembled into a fabric or fabric, i.e. a kind of a textile normally being flexible and bendable. Glass fibres are typically composed of glass filaments bundled into a roving. The diameter and number of filaments in a roving may vary leading to the variations of the diameter of a roving. Normally the filaments are coated with a sizing. The glass fibres may be assembled into a fabric by any suitable method, such as by stitching. Useful glass fibre fabrics include those having of one or more layers of fibres, which preferably are multiaxially rein-forced. By the term “unidirectional” is meant that the fibres in one layer of fabric are parallel. By the term “multiaxial reinforcements” or simply “multiaxial” is meant fabric made up of multiple plies or layers of parallel fibres, each lying in a different orientation or axis. In a preferred embodiment of the subject invention the glass fibre fabric comprises multiaxial reinforcements, wherein layers of unidirectional fibres are assembled and stitched together, thereby providing strength and stiffness in multiple directions depending on the controlled orientation of the fibres. Useful multiaxial fabrics include unidirectional, biaxial, and triaxial and quadriaxial fabrics, for example those that are tailored to have the reinforcement in four main directions, i.e. 0 degrees, 90 degrees, +45 and −45 degrees. However, multiaxial fabrics having other directions between 45 degrees and 90 degrees may be employed.

Useful multiaxial fabrics may further comprise a chopped strand mat layer, or different types of surface mats added on one side of the fabric and then it is referred to as combination products. The multiaxial glass fibre fabrics are normally range in weight from 100 g/m2 to 2500 g/m2, such as from 200 g/m2 to 1200 g/m2.

Useful glass fibre fabrics normally comprise various glass types, including but not limited to E-glass, S-glass, R-glass, H-glass, D-glass and ECR-glass fibres. Alternatively or in combination, non-woven glass fibre materials or felts may also be employed.

Glass fibres possess inherent fire-resistant properties due to their physical and chemical composition, making them highly suitable for applications requiring fire resistance. Glass fibers have a very high melting point. They can withstand temperatures significantly higher than many other materials before they begin to melt or degrade. This property makes glass fiber mat an excellent barrier against heat and flame. Also, glass fiber mats are effective thermal insulators. The dense arrangement of fibers can block heat. They can help prevent the transfer of heat from one side of the mat to the other. This insulation property is essential in protecting structures and components from heat damage during a fire.

In a preferred embodiment, for hand-lay-up, the fabric is typically into the desired shape and embedded into a polymeric matrix comprising a resin component before the final shape of the product is made, whereas for industrial applications, a prepreg process as set out herein below is preferably used.

The glass fibre fabric material may have different glass fibre dimensions and different thickness as well being coated with various types of sizing. Normally, the diameter of a glass filament is about 3-25 μm. Furthermore various sizes of rovings may be used, where the term roving is used in it's conventional meaning, namely a bundle of glass fibre filaments.

Preferably, the process may also involve incorporating a thermoplastic foam as a core layer, which is essentially a porous polymeric matrix layer, and then applying the prepreg material to at least one side of this core layer. This technique results in the production of composites that are less dense and have higher insulation values.

Similarly, after curing the resin in the mineral (glass) fibre fabric, the outer layers are bonded very well to the core layer surfaces. While the outer layers may be applied in a wet laying process, preferably this is done using a prepreg material comprising a gelled polyfuranyl resin composition.

The curing and bonding of the composite material is then preferably performed by a simultaneous pressing and heating step, whereby the outer layer is compressed slightly. Preferably, therefore, the outer layers act not only as resilient composite skin layer once cured, but also as an adhesive layer, thereby strongly adhering and bonding the outer layer effectively to the core later surface. The present inventors have found that this is a surprisingly convenient way to bond outer inorganic fibre fabric layers with at least one core layer in between.

In order to further improve fire resistance properties, one or more components of the composite material may be treated with a fire retardant. This can have the effect of reducing flame spread, smoke formation and/or heat output during combustion. The fire-retardant treatment may be applied to the inorganic fibre skin, the natural fibre core and/or the low-density core layer. Suitable fire retardants may be selected from the group consisting of: metal hydroxides, and endothermic additives such as: alumina trihydrate, magnesium hydroxide; borates such as ammonium borate, zinc borate, sodium borate, barium borate; halogenated flame retardants, such as brominated or chlorinated additives; antimony trioxide; phosphorous additives including organic and inorganic phosphates as salts or esters, alkylphosphinates, hypophosphite salts; expandable graphite; molybdenum compounds; and/or melamine cyanurate.

It was found that the use polyfuranyl resins comprising polyfurfuryl alcohol (PFA) polymers, in particular under acid catalyst, such as p-toluene sulphonic acid, delivered an inherently high flame retarding effect.

Surprisingly, the composite material according to the invention was found to achieve a flame retardancy rating of B S1 D0 according to NEN-EN 13501-2018 SBI.

This renders this material particularly suitable for use in articles of sustainable and recyclable fire-resistant furniture, a building exterior or interior panel, or an exterior or interior finishing material.

Preferably, the step of contacting the core layer with a resin and glass fibre fabric comprises preparing a pre-gelled polyfuranyl resin and glass fibre fabric prepreg. The use of a prepreg material advantageously allows for a process without a prolonged solvent removal step, such as by heating or at reduced pressures.

Thus, the lightweight composite material comprises a first layer and a second layer having a polyfuranyl resin as main binder component. The polyfuranyl resin employed in the present invention may be selected from a variety of different binder materials comprising PolyFurfuryl Alcohol (PFA). The selection will largely depend on the cost and performance targets specified.

The polyfuranyl resin as a binder material further has the advantage of being a non-toxic thermoset binder material. The use of such materials allows to avoid toxic or environmentally harmful emissions of volatile compounds, as well as reduced exposure for the applicator to small molecules. Also, the use of thermoset polymers results in a much higher strength obtainable by these components, at elevated temperatures was found that the use polyfuranyl resins comprising polyfurfuryl alcohol (PFA) polymers, in particular under acid catalyst, such as paratoluene sulphonic acid, delivered an inherently high flame retarding effect.

“Furan” or “polyfuran” resins derived from biomass of vegetable origin are one of the solutions used. Such polyfuranyl resins were initially used in the foundry for ensuring setting of moulding sands in the mould, and are now also used as binders for mineral fibres for making insulation products based on mineral wool, see for example WO 93/25490; WO 94/26676; WO 94/26677; or WO 94/26798.

The light weight, fire-resistant plate-like composite material comprises a first layer and a second layer comprising a polyfuranyl resin as main binder component. The polyfuranyl resin employed in the present invention may be selected from a variety of different binder materials comprising PolyFurfuryl Alcohol (PFA). The selection will largely depend on the cost and performance targets specified.

The polyfuranyl resin composition may be a biologically derived resin. As such, the biologically derived resin advantageously is not a phenolic resin based on mineral oil as may be found in connection with the manufacturing of conventional fire-rated laminates. The biologically derived resin preferably is a resin that derives some or all of its constituent monomers from biological sources.

Preferably, the biologically derived resin comprises PolyFurfuryl Alcohol (PFA) as the polymeric backbone component. In some embodiments, the biologically derived resin does not comprise fire resistant filler or additive material. Advantageously, such systems can be prepared comprising no Volatile Organic Compounds (VOC) as typically found in phenolic or epoxy resins. As a result, the biologically derived resin may reduce exposure to potential chemical hazards that may otherwise typically occur during manipulation of phenolic or epoxy resin.

Where reference is made to a “biologically derived resin”, it is to be understood that for embodiments of the invention, the biologically derived resin is a furan resin, such as a resin comprising monomer units of furfuryl alcohol. The cured resin may therefore be a poly(furfuryl alcohol). The furanyl resin may be derived from sugar cane, or other sources of sugars, and as such is not only entirely sustainable, but also imparts particularly advantageous properties to the subject assembly. Preferably, the furan resin comprises furfural (furan-2-carbaldehyde) or a derivative of furfural such as furfural alcohol, furan, tetrahydrofuran and tetrahydrofurfuryl alcohol, which are collectively referred to as “furans” herein.

Accordingly, useful polyfuranyl resins comprise mixtures of monomers, oligomers and polymers obtained by polycondensation of monomers with a furanyl nucleus and optionally other comonomers such as anhydrides, aldehydes, ketones, urea, phenol etc., in an acid medium. Such polyfuranyl resins usually comprise furfural and/or a derivative of furfural such as furfuryl alcohol. Polyfuranyl resins are typically prepared by self polymerisation of furfuryl alcohol and/or furfural.

In a preferred embodiment, the resin may comprise a polyfurfuryl alcohol, a liquid polymer which self-crosslinks in the presence of an acid catalyst. Polyfuranyl resins may be modified by using furfural instead of formaldehyde in a conventional production of a phenolic resin. The furan resin then polymerizes in the presence of a strongly acidic catalyst via various condensation reactions.

Polyfuranyl resins are inherently sustainable, since they are derived from natural, renewable sources, and were found to bond well to mineral fibres, and they have good flame-retardancy properties.

As set out above, the polyfuranyl resin composition preferably comprises an acid catalyst. The catalyst promotes curing via condensation reactions, thereby releasing water vapour. During the curing step, preferably means to release the formed vapour or steam are provided. The curing step typically takes place in a heated moulding press. Known moulding presses are known for moulding polyurethane-containing products. Such moulding presses are typically operated in a carefully sealed condition, in view of the health and safety issues surrounding the curing of polyurethane.

The binder composition further preferably comprises an acidic polymerization initiator having a pKa at 25 °C of at least 3. Such initiators can be selected from Brønsted and Lewis acids. The acidic initiators may be organic or inorganic. Examples of inorganic Lewis acids include aluminium trihalide, e.g. trichloride, boron halide, e.g. trichloride, zinc halide, e.g. dichloride, iron halide, such as ferrous chloride and ferric chloride, chromium halide, such as chromium trichloride, and iodine. Preferably, the acidic initiator is organic and suitably selected from maleic anhydride, phthalic anhydride, formic acid, maleic acid, malic acid, phthalic acid, furoic acid, benzoic acid, furan-dicarboxylic acid, citric acid, levulinic acid and combinations thereof. The acidic initiator is suitably added in an amount that provides for a sufficiently fast and complete polymerization reaction, especially when heated to the desired thermosetting temperature. Preferably, amount of acidic initiator is in the range of 0.5 to 10% wt, based on combined amount of furfuryl alcohol and, where applicable humins.

In addition, the particulate binder may also contain a prepolymer of furfuryl alcohol. The prepolymer is a resinous product and is available under the trademark Furolite™ (ex TransFurans Chemicals). The preparation of these prepolymers is known in the art. An example of a known preparation method is described in U.S. Pat. No. 2,571,994.

The particulate binder may further comprise further additives, such as pigments, fillers, flow improvers, catalysts, wetting agents and other usually applied additives.

A furan resin may be used in which furfural replaces formaldehyde in a conventional production of a phenolic resin. The furan resin cross links (cures) in the presence of a strong acid catalyst via condensation reactions. Furfural is an aromatic aldehyde, and is derived from pentose (C5) sugars, and is obtainable from a variety of agricultural by-products. It is typically synthesized by the acid hydrolysis and steam distillation of agricultural by-products such as corn cobs, rice hulls, oat hulls and sugarcane bagasse. Furan resins are of particular interest because they are derived from natural, renewable sources, they bond well to glass fibres and they have good flame-retardancy properties. Further details relating to furan resins whose use is contemplated in the present invention is set out in “Handbook of Thermoset Plastics”, edited by Sidney H. Goodman, Edition 2, Published by William Andrew, 1998, ISBN 0815514212, 9780815514213, Chapter3: Amino and Furan Resins, by Christopher C. Ibeh. Furan resins are of particular interest because they are derived from natural, renewable sources, they bond well to glass fibres and they have good flame-retardancy properties.

Preferably, humins may be added to the furfuryl alcohol. In this specification, humins from biomass sources are understood as the often black or dark coloured carbon-based macromolecular substances obtained from om saccharide-based biorefinery processes, in particular those from conversion of 5-hydroxymethylfurfural (HMF). These humins can be in the form of either viscous liquids or solids depending on the process conditions used.

These compounds can be considered as polymers containing moieties from hydroxymethyl-furfural, furfural, carbohydrate and levulinic acid. These coloured bodies are produced as by-products in the partial degrading of carbohydrates by heat or other processing conditions, as described in e.g. EP 338151 A1. Humins are believed to be macromolecules containing furfural and hydroxymethyl-furfural moieties. Further moieties that may be included in humins are carbohydrate, levulinate and alkoxymethylfurfural groups.

The polyfuranyl resin of the first layer or the second layer, or both layers may also include one or more additional compounds, optionally selected from additional monomers, co-catalysts, diluents, fillers and combinations thereof.

Additional monomers may advantageously be selected from 5-hydroxymethylfurfural (HMF), 2-(2-hydroxyacetyl)furan, 5-alkoxymethylfurfural, formaldehyde, methyl formate, levulinic acid, alkyl levulinates, 2,5-diformyl-furan, carbohydrates and furfuraland combinations thereof. The use of these monomers has the advantage that similar moieties can already be present in the humins so that these additional monomers seamlessly integrate with the polymer of furfuryl alcohol and the humins. The relative amount of these additional monomers may vary within wide ranges. When they are elected from the compounds hereinabove, these compounds have groups that are also present in humins. Therefore they can be added to the humins in very small to extremely large quantities. Generally, economic considerations promote that a small amount of additional monomers is used and a large amount of the by-product humins. Commonly, the amount of additional monomers may vary from 0 to 20 % wt, based on the combined amount of furfuryl alcohol and humins.

In a particularly preferred embodiment, the processes comprises the additional step of blending glass fibre and a particulate binder comprising polyfuranyl resin. This step may be performed by any suitable method, including mechanical methods, and/or advantageously the use of cyclone technology, which may equally allow to pre-heat binder and fibrous material, as may be required for a continuous production. In such a line-up, the two materials, together with any additive or other material as required may be advantageously be blended and premixed from e.g. two silos, and then mixed intensively while already pre-heating to allow for an improved flow if a homogenous composite with a thermoset binder is desired. Alternatively, the process may be performed batch-wise.

The benefit of such a batch production is the relative ease of heating and shaping, but equally also the fact that a less homogenous material may be obtained, which can be advantageous if porous matrix materials are present as well, whereby a full saturation of cavities in the matrix may be avoided, thereby maintaining high insulation values and low density. In the process according to the invention, the blended material obtained in step (a) is preferably shaped prior to, or during the curing step, to obtain a shaped composite article.

Preferably, the process further comprises adding one or more woven or non-woven sheet or fabric material to at least one side of the composite blend. This may be for simply decorative purposes, as well as UV filtration by using a pigmented or printed foil, or functional such as the use of glass or carbon fibre mats or fabric for increased strength.

The process/method according to the invention further comprises heating the composite material such that the polyfuranyl resin is flowing and curing. Preferably, where the polyfuranyl resin is provided as part of a particulate binder, the process according to the invention comprises the step of heating the composite material such that the gelled binder material is flowing and concurrently.

The heating of the uncured laid up composite material may be done by any suitable heating means. According to a continuously operating embodiment of the invention, the blend of mineral wool and polyfuranyl resin (or particulate binder comprising polyfuranyl resin) is pressed and heated from one or both sides, preferably pressed between a heated roll and a transportation belt, or more preferably, between heated rolls. According to another preferred embodiment, the composite to be cured is passed through a heating area, preferably through a furnace, at a temperature of from 100 to 180 °C, preferably of from 110 to 160 °C, yet more preferably of from 120 to 150 °C.

According to a further preferred embodiment of the invention, the composite may be heated by radiation, such as microwaves to ensure that the core of the composite material also is heated. Alternatively, and most easily, the process may be performed in a batch-wise operation, wherein the mould with the composite material is heated, advantageously in an oven. Preheating of the polyfuranyl resin, the binder material or the blended material comprising polyfuranyl resin and mineral prior to introduction into the mould may also be performed, provided that in case of a thermoset binder, the heat supply should be limited to not allow the material to cure completely.

This allows adapting the curing cycle to the particulate binder material in the case of thermoplastic binders.

Preferably, the increased temperature refers to a temperature in the range of from 100 to 250 °C, preferably 120 to 200 °C, yet more preferably 130 to 150 °C. The pressure may be any pressure that is suitably applied, and may range from ambient pressure or slightly above that, such as the pressure exerted by a vacuum bag, to a pressure of several tons per square meter, as suitably applied by e.g. a hydraulic press. Preferably the pressure ranges of from 0.1 MPa to 10 MPa, preferably from 1 to 7 MPa, again more preferably from 2 to 6.5 MPa. The unit pressure applied to the moulding material in a mould. The area is calculated from the projected area taken at right angles to the direction of applied force and includes all areas under pressure during the complete closing of the mould. The unit pressure, expressed in kg per square centimetre, is calculated by dividing the total force applied by this projected area. This is particularly suitable as a high-volume, high-pressure process suitable for a semi-continuous or continuous mode of operation. The time required to achieve a suitable strength and appearance depends largely on the kind of particulate binder used, but may range from several seconds, e. g. at high pressure and temperature, to several hours.

Preferably, the time wherein the increased temperature and pressure are applied ranges of from 1 s to 10 hours, more preferably from 5 s to 5 h, yet more preferably from 30 s to 3 h, again more preferably from 1 min to 1 h. Furthermore, the material may be pre-heated, and/or post-cured as required.

Suitable mineral fibres are in particular glass fibres, notably of glass E, C, R or AR (alkali-resistant), or rock fibres, notably of basalt (or wollastonite). These fibres may be fibres containing more than 96 wt % of silica and ceramic fibres based on at least one oxide, nitride or carbide of metal or of metalloid, or a mixture of these compounds, in particular at least one oxide, nitride or carbide of aluminium, of zirconium, of titanium, of boron or of yttrium. More particularly, the mineral fibres according to the invention are aluminosilicate glass fibres, notably aluminosilicate glass fibres comprising aluminium oxide, Al₂O₃, in a fraction by weight of between 14% and 28%.

However, for the materials of the present invention, in particular where thicker surface layers are provided, it is preferred that a steam ventilation is provided. The steam vent may take the form of an additional process step, in which the mould press is opened (at least partially) during the curing step in order to release steam that has been generated during the heating and curing of the material. In that case, the mould presses typically then closed again to complete the curing of the material. The steam vent may take place at 1 minute or less from the closure of the moulding press, more preferably at 45 seconds or less from the closure of the moulding press.

Additionally or alternatively, the steam vent may take the form of suitable openings provided in the mould press throughout the curing step, the openings being placed so as to provide a suitable exit route for steam generated during the heating and curing of the material.

Steam ventilation can also be achieved by the use of holes (e.g. drilled holes) in the tool face, providing a steam exit route out of the tool. It is possible to consider the cycle time of the manufacture of a composite material according to the present invention. The cycle time is considered to be the time between corresponding steps in the manufacture of a first composite material and a subsequent composite material in the same moulding apparatus. Preferably, the cycle time here is 150 seconds or less. More preferably, the cycle time is 120 seconds or less, e.g. about 100 seconds. For large panels, however, the cycle times may be longer, e.g. up to 240 seconds.

Where an exterior application is considered, waterproof membranous materials for use in accordance with the invention may be included in the line-up. Some more specific examples of suitable waterproof membranous materials include; styrene butadiene modified bitumen, tactic polypropylene modified bitumen, polyalphaolefin modified bitumen, ethylene propylene diene monomer, chlorosulphonated polyethylene, polyvinyl chloride, copolymer alloys, polyisobutylene, butadiene acrylonitrile alloys and nitrile butadiene polymers, chlorinated polyethylene and neoprene or chloroprene. Suitable methods for applying these materials to the metal sheet will vary with the material to be used and will no doubt occur to the skilled person. Alternatively, or additionally, fireproof membranes may also be included.

For insulation, the core material preferably is provided in the form of a board of polymeric foam or mineral wool insulation, or a combination thereof. Furthermore, various foils maybe laminated into the exterior of the panels, e.g. for decorative or protective purpose.

In a preferred embodiment, the core layer for insulation may comprise a polymeric matrix, an inorganic matrix, or combinations thereof. The insulating material may have a nominal thickness in the range 1.5 to 20 cm, preferably in the range 2 to 12 cm; and/or a thermal resistance R value of equal to or below (≥) than to 3 m2K/W, preferably wherein R≥to 4 2K/W at a thickness or 200 mm; and/or a thermal resistance R of R ≥to 1.5 m2K/W, preferably R≥to 2 m2 K/W at a thickness or 100 mm; and/or a density in the range of from 5 to 40kg/m3.

Preferably, the core layer in the form of an insulation layer may comprise a mineral wool is selected from glass wool, stone wool, and/or ceramic fibre wool. The mineral wool or fbres may be glass wool or rock wool; the fibres may have an average diameter between 2 and 9 micrometers; they may have an average length between 8 mm and 80 mm.

Mineral wool herein refers to any fibrous material formed by spinning or drawing molten mineral or rock materials such as slag and ceramics. Applications of mineral wool include thermal insulation and soundproofing. Preferably the mineral wool is selected from glass wool, stone wool and/or ceramic fibre wool, in particular from alkaline earth silicate (AES) wool, aluminosilicate (AS) wool, polycrystalline (PC) wool, kaowool or glass wool.

Mineral wool is composed of individual fibres that conduct heat very well. However, in the physical arrangement of fibres within the mineral wool leads to low heat conduction from one fibre to another and when pressed into rolls and sheets, their ability to partition air makes them excellent insulators and sound absorbers.

A further aspect of the present invention relates to a process for manufacturing a composite material, wherein the process comprises the following steps: providing an insulation layer; contacting the insulation layer with a mixture comprising polyfuranyl resin and glass fibre on a first surface of the layer comprising mineral wool to provide a first layer comprising polyfuranyl resin and glass fibres ; contacting the insulation layer with a mixture comprising polyfuranyl resin and glass fibre on a second surface of the layer comprising mineral wool to provide a third layer comprising polyfuranyl resin and glass fibres; heating the composite material comprising the three layers under pressure.

Preferably, the layer comprising mineral wool is a glass wool. Glass wool for instance is an insulating material made from fibres of glass arranged using a binder into a texture similar to wool. The process traps many small pockets of air between the glass, and these small air pockets result in high thermal insulation properties. Glass wool may be suitably manufactured by the method of U.S. Pat. No. 2,133,235 A.

Preferably, the step of contacting the insulation layer with a resin and glass fibre fabric comprises preparing a pre-gelled polyfuranyl resin and glass fibre fabric prepreg. The use of a prepreg material advantageously allows for a process without a prolonged solvent removal step, such as by heating or at reduced pressures.

Alternatively, the core layer as an insulation material layer may comprise a foamed polymeric material for increased thermal or otherwise insulation. Preferably, the present invention advantageously makes use of a thermoplastic foam material having a low thermal conductivity and preferably comprising a strong cellular orientation with aspect ratio significantly larger than 1.5, ideally even larger than 2.0. The present invention discloses also a shaped composite article obtained from the foam material. In the preferred foam material, additionally polymer blends are present in an amount of not more than 40 wt % and wherein the additional polymer blends are selected from the group of polyalkylene terephthalates, polylactic acid, polycarbonate, polyolefins, polyacrylates, polyamides, thermoplastic elastomers, core-shell polymers, liquid crystal polymers (LCP), or a mixture thereof.

Particularly preferred are polyester-based material, preferably comprising virgin and/or post-consumer polyethylene terephthalate that have a starting IV from 0.56 up to 0.82. Preferably, these are obtained by a reactive foam extrusion. Herein, the IV of the polymer is increased in a single step to a satisfactory level while at the same time a physical blowing agent introduced to the mixture, and consequently a sudden pressure drop will result in the physical blowing agent rapidly expanding and foaming the PET. Virgin material is defined as raw material coming from PET producer, and may be supplied in form of powder or granules (pellets). Post-consumer material is typically available in form of flakes or granules, and may contain any products made of PET, such as bottles, food packaging material or blisters, which have been collected, shredded and washed by special recycling companies.

Preferred polyester-based materials comprise preferably virgin and post-consumer polyethylene terephthalate that have a starting IV from 0.56 up to 0.82, and are expanded by means of reactive foam extrusion. Preferably, the IV of the polymer is increased in a single step to a satisfactory level while at the same time a physical blowing agent is introduced to the mixture.

Virgin material is defined as raw material coming from PET producer, and may be supplied in form of powder or granules(pellets). Post-consumer material is typically available in form of flakes or granules, and may contain any products made of PET, such as bottles, food packaging material or blisters, which have been collected, shredded and washed by special recycling companies.

The final shape of the foam extrudate is defined by an extrusion tool and a shaping tool which helps the foam to maintain its shape during solidification and cooling.

A preferred thermoplastic foam material is a polyester based material and wherein the polyester is virgin or post-consumer polyethylene terephthalate, or a mixture of the two and wherein the foam material is characterized by elongated cells, which have an aspect ratio larger than 1.5, and by a density according to ISO 845 of lower than 150 kg/m3 , preferably lower than 80 kg/m3, and by a thermal conductivity of lower than 0.032 W/mK measured according to ISO 12677.

Preferably the process further may comprise adding at least one porous polymeric matrix layer, and applying the prepreg material to at least one side of the foamed polymeric matrix layer.

This will result in less dense composites with higher insulation values.

In a preferred embodiment, the lightweight plate-like composite material may comprise a core layer made of foamed virgin and/or post-consumer polyethylene terephthalate, and a first and second layer made of glass fibre impregnated with polyfuranyl resin, where the core layer is positioned in-between the first and second layers.

Preferably, the composite materials further comprise a wood composite layer, to increase the stability, and to allow for attachment of various fixing or positioning mean in a building structure. Preferably, the wood composite layer is an oriented strand board. The wood composite layer preferably has a thickness of from 10 mm to 35 mm, preferably at least 12-25 mm, yet more preferably 15-20 mm.

Preferably, the lightweight, fire-resistant plate-like composite material may also comprise further layers, such as wood composite materials suitable for wood composite layer, veneer layers, or decorative layers. Preferred wood materials may be selected from the classes 1 to 4 of OSB materials, e.g. OSB/1, i.e. boards with no load transfer, OSB/2-board, i.e. with load transfer properties, suitable for applications in dry conditions; OSB/3 boards, i.e. boards with load transfer properties, suitable for usage class according to PN-EN 13986 applications in moderate humidity conditions, or OSB/4 boards, designated as special heavy-duty boards for loadbearing applications, as determined by the DIN EN 300 standard. The wood composite layers may have a suitable thickness as adequate for loadbearing uses and dimensional stability, whereby a greater thickness will increase the required structural strength.

The present composites may also comprise further functional layers, such as fire resistance layers, or foils or veneer layers for visual effects, or humidity. Such layers may advantageously be applied into the prepreg outer layers, and then integrally formed with the composite material.

The present composite material may also include one or more voids or channels, which are useful to accommodate a variety of different building related elements, such as HVAC equipment and ducts, electricity and telecommunication cables and wiring, plumbing and other important connections; and/or the channels may comprise suitable sound or energy loss insulating materials. Depending on the use and location, these may allow the passage of the cables, wiring, and plumbing along a length. The channels may have also preformed openings in the sides to accommodate the passage of cables, wiring, and plumbing along the panel, or, where desired contain the cables, wiring, and plumbing with standard connectors.

The composite material may further comprise additives, such as pigments, fillers, and other usually applied additives.

The composite material preferably further comprises at least one woven or non-woven sheet layer, to improve the mechanical properties such as tensile strength and surface resilience. The composite material may further comprise cover sheet material to create an exterior expression, such as coloured films, preferably also comprising a UV filter, printed films, printed paper or carton box, woven or non-woven fabrics.

The present invention further preferably relates to a shaped article comprising the composite material according to the invention, such as advantageously in the form of a flat, square-shaped panel module for use in assembling building structures. Such panels may also advantageously be employed as replacement for fibre enforced concrete panels in structural applications, such as sound proofing.

In another aspect, the present invention relates to a method for the manufacture of a composite panel using a lightweight plate-like composite material, the method comprising:
a. Impregnating a sheet comprising woven mineral fibres with a liquid polyfuranyl resin composition, to provide an impregnated sheet;
b. subjecting the impregnated sheet to conditions inducing gelation of the polyfuranyl resin composition, thereby forming a prepreg sheet,
c. optionally depositing a prepreg sheet onto a transport medium, preferably a backing sheet and optionally removing the prepreg sheet on the backing sheet;
d. arranging at least a core layer between two prepreg sheets, such that such that the top surface of the second sheet opposes the bottom surface of the first sheet, to form a sandwich structure; and
e. subjecting the sandwich structure to conditions that allow the gelled polyfuranyl resin composition to cure essentially fully, preferably including heating the sandwich structure to a temperature and for a time period that results in crosslinking and chain growth of the polyfuranyl resin composition.

Preferably, where a shaped article comprising the composite material according to the invention is a panel, such panels can be used to insulate flat surfaces such as cavity wall insulation, ceiling tiles, curtain walls, and ducting.

The present composite materials were found to reduce the CO2 footprint significantly as compared to other composite materials or to traditional wood or steel skeleton buildings. Also, the components are entirely sustainable, and/or reusable.

For furniture applications, the core material preferably is a lightweight porous materials such as cork and balsa wood, corrugated cardboard and/or paper honeycomb.

Panels may advantageously also contain side portions, such as wooden or polymeric slats or moldings, which may provide additional structure and functionality. Alternatively, the skin maybe provided by the exterior sheet.

Preferably, when shaped into panels, the edges of the composite panel comprise a higher amounted the composite material to increase mechanical strength. The process may be advantageously be performed in a heated press.

The composite materials may be formed by either a batch process or a continuous process.

The present invention further relates to the use of the optionally shaped composite article as building or insulation sheet material, as decorative and/or functional wall panels, e.g. as noise sup-pression or as panels for wall insulation. The optionally shaped composite article may also be advantageously used for filling stud cavities in wall of roof insulation assemblies.

In a further aspect, the invention relates to a composite material for use as a façade produced by the processes of the invention as described above.

In a further aspect, the invention relates to the use of a composite material as a building material, preferably as for use as sound and/or heat insultation building material.

The present composite materials were found to reduce the CO2 footprint significantly as compared to other composite materials or to traditional wood or steel skeleton buildings. Also, the components are entirely sustainable, and/or reusable.

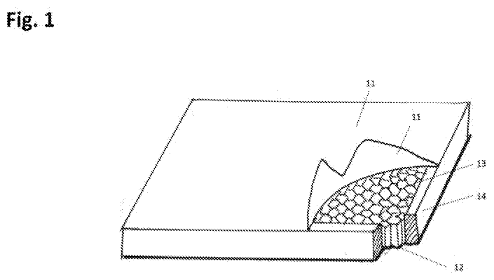

FIG. 1 is a perspective view of a preferred embodiment of the plate-like composite material according to one embodiment of the invention, showing a peel-away section (11) of the exterior sheet comprising a glass fibre thermoset composite layer, and a top layer attached to the outer layer (not shown); a paper honeycomb core material, a side and corner enforcement element 15, a glass fibre thermoset composite layer, and a top layer attached to the composite.

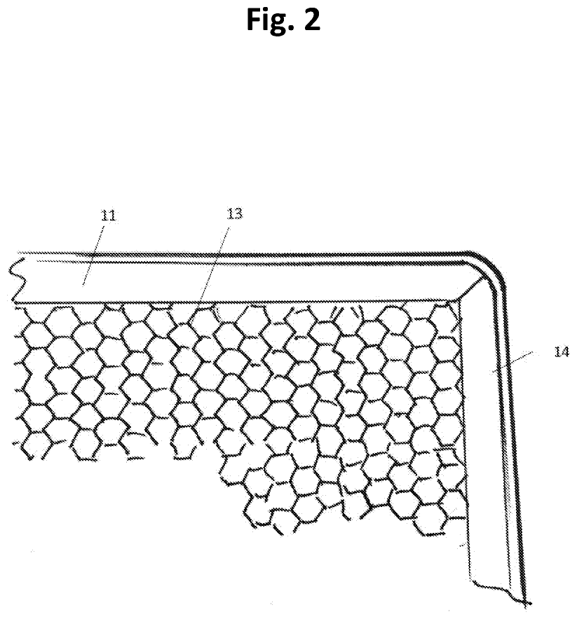

FIG. 2 is a top view of a preferred embodiment of the invention, showing the internal core layer comprising a honeycomb paper or card-board core (13) and a side element (14).

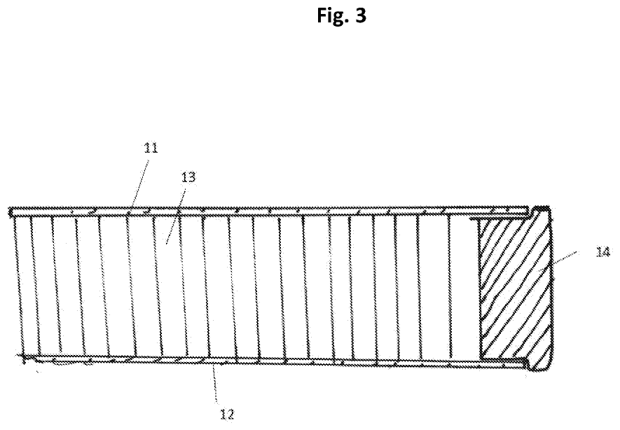

FIG. 3 shows a cross-sectional view of a preferred embodiment of the invention, a table top comprising a top layer (11), a bottom layer (12), a core layer (13), and a side molding (14) laminated into the panel.

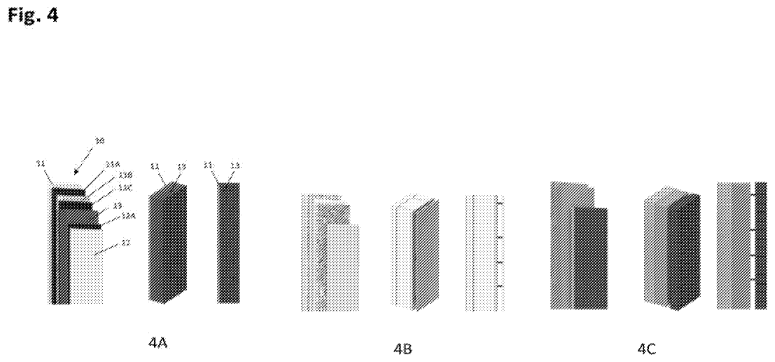

The panel of FIG. 4A represents a preferred embodiment of the present invention, as compared to conventional facade panels 4B and 4C. In FIG. 4A, and shows generally at reference numeral 10. The composite panel 10 includes surface layers 11 of a cladding material, and may further comprise a decorative and/or functional layers, such fire resistance layers, humidity and weather resistant layers, and may have aspects of as stone, glass, ceramic, wood, textiles paper or polymer foils or a combination of these materials. Any cladding material which can be bonded to a core can be used as the cladding surface. The preferred composite panel 10 of FIG. 4a includes a core layer 13 to which the surface layer 11 of cladding material is bonded via a prepreg sheet 11A. The core layer 13 is preferably formed of a material which may define tongue 13B which cooperates with a groove 13 in a groove member defined between spaced-apart extensions 13A and 13C.

The core layer may advantageously comprise different layers, e.g. OSB panels or similar structural materials, and various different coating layers. Two conventional panels are also shown in FIGS. 4B and 4C for comparison. These typically comprise gypsum board, two glass wool panels with a timber frame and intermittent OSB panels, an air-filled cavity with a mounting system, and solid outward facing panel (4B); or a concrete sheet, a PIR HR insulation foam layer, an air cavity and a brick work layer (4C).

The panels may have various applications, particularly where impermeability to humidity, in particular water, is a desirable feature for a structure. By suitable adaption of the panels to suitable scales and shapes and/or the membranous sheet laminate, they may be used in the efficient assembly of, for example; furniture, such as table tops, door panels, cupboard, kitchen tops and doors, interior decorative panels, lining of various structures, and interior insulation panels.

The present invention also pertains to a structural elements, including a planar surface layer of the composite material. Herein, the at least one core layer may be bonded to surface layers, and include one or more outwardly-extending attachment flanges defined by the thickness of the substrate layer and proximal to the surface layer around two adjacent side edges for receiving fastener elements through the thickness of the core layer and into the support member.

One or more tongue sections may preferably project outwardly from the flange remote from the surface layer, whereas two spaced-apart elements define a groove therebetween extending along adjacent sides of the substrate layer for receiving the tongue of a complementary adjacent structural element. The flange may reside at all points intermediate the tongue and the surface layer for permitting the tongue to fit into the groove of a complementary structural element, for permitting a closed surface once two or more adjacent structural elements are coupled.

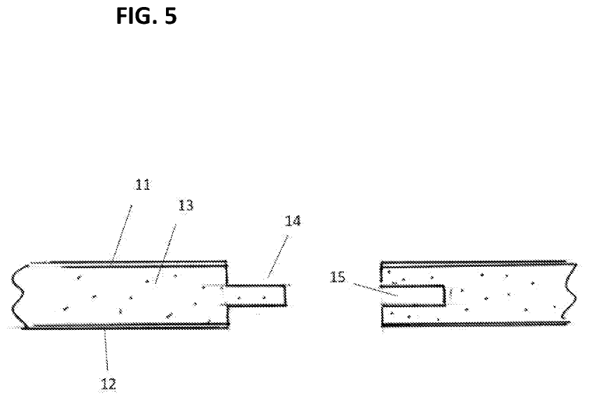

As shown in FIG. 5, an attaching portion 14 of the core layer may project outwardly beyond one side edge of the surface layer 11. This attaching portion 14 provides an exposed, solid structure through which fasteners (not shown) such as nails, screws or bolts can be extended into a supporting structure. Advantageously, the length of the attaching portion 14 matches the length of an overhang portion of the surface layer 11 over the opposite side of the core layer 12. Hereby, opposite longitudinally-extending side edges of the composite panels 10 may complement each other, so that a plurality of composite panels 10 can be placed side-by-side in a complementary, interlocking array. Fasteners may advantageously be placed into the attaching portion 14 at any point and with any spacing necessary to achieve a required degree of attachment.

The use of fasteners with flat heads or countersinking is desirable to achieve a flat, regular surface on which the adjacent surface layer 11 will be supported, and reddening adhesives or support members unnecessary. Holes for fasteners such as screws or bolts are advantageously preformed during manufacture, thereby preventing leakage of water, or cold bridges.

By reference back to FIG. 5, it can be seen that the attaching portion 14 may extend around onto the end edge of the core layer 13, for combination with a recess (15). Thus, opposite laterally-extending side edges of the composite panel 10 complement each other, so that a plurality of composite panels 10 can be placed end-to-end in a complementary, interlocking array. As shown in FIG. 5, an attaching portion 14 of the core layer may project outwardly beyond one side edge of the surface layer 11. This attaching portion 14 provides an exposed, solid structure through which fasteners (not shown) such as nails, screws or bolts can be extended into a supporting structure. Advantageously, the length of the attaching portion 14 matches the length of an overhang portion of the surface layer 11 over the opposite side of the core layer 12. Hereby, opposite longitudinally-extending side edges of the composite panels 10 may complement each other, so that a plurality of composite panels 10 can be placed side-by-side in a complementary, interlocking array. Fasteners may advantageously be placed into the attaching portion 14 at any point and with any spacing necessary to achieve a required degree of attachment.

The use of fasteners with flat heads or countersinking is desirable to achieve a flat, regular surface on which the adjacent surface layer 11 will be supported, and reddening adhesives or support members unnecessary. Holes for fasteners such as screws or bolts are advantageously preformed during manufacture, thereby preventing leakage of water, or cold bridges.

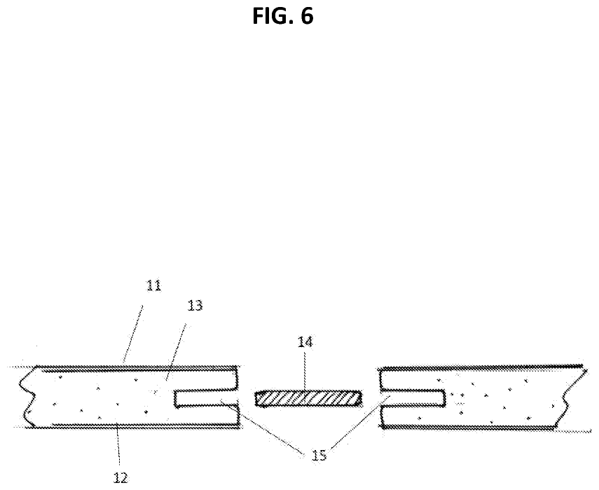

Referring now to FIG. 6, a composite panel 10 is shown having a similar structure, but wherein the surface layer 11 of cladding material and the core layer 13 are oriented such that the surface layer 14 may project outwardly. An attaching portion 15 of the core layer 13 may comprise part of a groove 15 defined by spaced-apart extensions 11 and 12. Fasteners 16 are extended through the attaching portion 24, which resides between the edge of the cladding layer 21 and the innermost portion of the groove 25 in the manner shown in FIG. 6.

Referring now to FIG. 7, an alternative construction is shown wherein a composite panel 10 includes a surface layer 11 of cladding material supported on first and second spaced-apart core layer segments 13. The first core layer segments each include a groove 15, for receiving a fastening element 15. The core layer segment 13 carrying the groove 14 can be positioned as shown in FIG. 7 to receive fasteners, if desired.

A composite panel is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

The present invention is described below in detail in reference to illustrative examples.

### EXAMPLE 1

A biaxial fabric glass fibre mat having an area unit weight of 800 g/m2 was coated with a furan resin solution in water comprising an acid catalysts, as obtained from Trans Furans Chemicals bvba. The glass fibre mat was impregnated with the resin to obtain an impregnated mat (pre-preg), and then submitted to a gelation process at a gelation temperature of 85 °C and for suitable period to for a semisolid material, which was deposited on a polypropylene backing sheet, and rolled onto a reel. The cover factor of the prepared prepreg was above 95%. Before lamination and fabrication, the tackiness of the prepreg was measured and found to be 0.15 MPa; when storing the prepreg at 15 °C and 50% relative humidity for 10 days, the tackiness was 0.12 MPa, showing little temporally caused change.

### EXAMPLE 2

A laminate stack was prepared comprising cardboard honeycomb core, and side elements were added to form the sidings and corners after the cure; and enveloped in one layer of prepreg sheet. The prepreg was the one produced in Example 1. The stack was packed in vacuum. Between the prepreg and the honeycomb core, no adhesive film was placed, and the prepreg was cured to be directly bonded to the honeycomb core.

The thus obtained panel proved highly fire resistant, light but strong, highly resilient, highly fire resistant, i.e. with a rating of B S1 D0 according to NEN-EN 13501-2018 SBI, and was found useful for furniture, e.g. tabletops or kitchen doors, or as decorative building panels.

### EXAMPLE 3

### Method for the Manufacture of Prepreg (Pre-Preg)

A prepreg material was prepared as follows: A liquid polyfuranyl resin composition comprising a furan resin dispersion in water, further comprising an acidic curing agent, was applied using a resin bath and scraper blade to a glass fibre fabric exhibiting cross lapping, having a weight of 250 g/m2. The impregnated glass fibre mat was then dried for 150 seconds at 110 °C in a series of calenders, to reduce the water content of the resin, and to pre-cure the resin to form a prepreg sheet. The prepreg sheet was then placed onto a non-stick polypropylene backing sheet, and rolled onto a storage roll.

### EXAMPLE 4

### Method for Manufacture of Facade Composite Panel

Then suitably sized sheets were cut from prepreg material as prepared in Example 3.

Then the following sandwich structure was prepared: an interior decorative surface film; a prepreg sheet as obtained from example 1, without a backing sheet; a core layer of recycled PET foam; and a third prepreg as obtained from example 1, without a backing sheet. Each glass fibre resin prepreg sheet had a nominal layer thickness of 2.5 mm and a density of 1950 kg/m3; the foamed PET core with a layer thickness of 145 mm and a core density of 50 kg/m3. The resultant sandwich construction was then placed in a moulding press, which was operated to press and heat the sandwich, and under vacuum. The moulding press was controlled in order to provide a steam vent step at different times during the curing process. After the preparation and curing of the sandwich, the resultant sheet was coated at an exteriorsurface with an UHS coating layer with a total layer thickness of 200 μm and a consumption of 200 g/m2. The final product has a total thickness of 155 mm. The resultant rectangular panel is further referred to as façade panel herein.

### EXAMPLE 5

### Fire Test

A façade panel prepared according to Example 4 was provided and its reaction to fire evaluated by the B S1 DO standard. The results showed that the composite facade panel according to the invention was surprisingly resilient to fire penetration, produced remarkably little smoke and no flaming droplets. These properties in combination allow the material to provide superior resistance to fire and are ideally suited for architectural uses in housing and office space provision.

Surprisingly, the composite material according to the invention was found to achieve a flame retardancy rating of B S1 D0 according to NEN-EN 13501-2018 SBI. This renders this material particularly suitable for use in articles of sustainable and recyclable fire-resistant furniture, a building exterior or interior panel, or an exterior or interior finishing material.

### EXAMPLE 6

### CO2/kg Calculation

The facade panel according to Example 4, however including an OSB board as outlined in FIG. 4A was compared with representative insulation facade panels of known art. The façade according to example 4 was compared to an insulated HSB facade (as in FIG. 4B) consisting of the following sequential layers: (1) 13 mm thick gypsum board, (2) 40 mm thick glass wool isolation with timber frame, (3) 18 mm thick orientated strand board, (4) 170 mm thick glass wool isolation with timber frame, (5) 18 mm thick orientated strand board, (6) 40 mm thick air-cavity with mounting system and (7) 12 mm thick solid surface face panel. As can be seen from FIG. 4, the facade according to the present invention is advantageously (1) lighter, (2) thinner) and requires less CO2 emissions/kg to produce than conventional insulted HSB facades.

The facade panel according to Example 4 was also compared to an insulated concrete façade consisting of the following sequential layers: (1) 130 mm thick concrete layer, (2) 145 mm thick PIR HR insulation foam, (3) 40 mm thick air cavity and (4) 90 mm thick brick work layer. The façade panel according to example 4 was significantly thinner, lighter per surface area covered, while providing at least the same, if not better insulation effect, at least the same flame resistance.

1-27. (canceled)

28. A lightweight, fire-resistant plate-like composite material for use in construction products, furniture applications, building elements, insulation, façade and/or roof cladding material, comprising:
a. a first layer comprising a crosslinked polyfuranyl resin and inorganic fibre fabric,
b. at least one core layer having a lower density than the first layer; and
c. a second layer comprising a crosslinked polyfuranyl resin and inorganic fibre fabric.

29. The lightweight fire-resistant plate-like composite material according to claim 28, wherein the at least one core layer is an insulation layer comprising an insulating core material, and wherein the at least one core layer is arranged in an intermediate position between the first layer and the second layer.

30. The lightweight fire-resistant plate-like composite material according to claim 28, wherein the at least one core layer comprises a mineral wool selected from glass wool, stone wool, and/or ceramic fibre wool; and/or a thermoplastic foam material selected from a foamed polyurethane, a foamed polystyrene, and/or a foamed polyester, more preferably foamed polyethylene terephthalate, or a cellular structure made of paper, cardboard.

31. The lightweight fire-resistant plate-like composite material according to claim 30, wherein the at least one core layer comprises a thermoplastic foam material, wherein the foam material is a polyester based material and wherein the polyester is virgin or post-consumer polyethylene terephthalate, or a mixture of the two and wherein the foam material is characterized by elongated cells, which have an aspect ratio larger than 1.5, and by a density according to ISO 845 of lower than 150 kg/m3, preferably lower than 80 kg/m3, and by a thermal conductivity of lower than 0.032 W/mK measured according to ISO 12677.

32. The lightweight fire-resistant plate-like composite material according to claim 31, wherein additionally polymer blends are present in the thermoplastic foam material layer in an amount of not more than 40 wt % and wherein the additional polymer blends are selected from the group of polyalkylene terephthalates, polylactic acid, polycarbonate, polyolefins, polyacrylates, polyamides, thermoplastic elastomers, core-shell polymers, liquid crystal polymers (LCP), or a mixture thereof.

33. The lightweight fire-resistant plate-like composite material according to claim 30, wherein the at least one core layer with a cellular structure has a honeycomb cellular structure, the honeycomb structure comprising internal walls arranged perpendicular to the planes of the first and second layers, or wherein the at least one core layer has a corrugated structure and is selected from corrugated fibreboard, paper, cardboard honeycomb, or a polymeric foam material, more preferably a thermoplastic foam material.

34. The lightweight fire-resistant plate-like composite material according to claim 33, wherein the composite material additionally comprises an additional outer coating layer on at least one side of the composite material, preferably an additional outer coating layer on at least two sides of the composite material, even more preferably an additional coating layer fully enveloping the first, second layers and at least one core layer.

35. The lightweight fire-resistant plate-like composite material according to claim 28, wherein the inorganic fibre fabric of the first and the second layers is selected from glass fibres, rock fibres, or carbon fibres.

36. The lightweight fire-resistant plate-like composite material according to claim 28, wherein the lightweight fire-resistant plate-like composite material has a fire rating of BS1 D0 according to NEN-EN 13501-2018 SBI.

37. The lightweight fire-resistant plate-like composite material according to claim 28, further comprising a structural layer or sheet.

38. An article of sustainable and recyclable fire-resistant furniture, a building exterior or interior panel, or an exterior or interior finishing material comprising the composite material according to claim 28.

39. A method for the manufacture of a prepreg sheet for use in formation of lightweight, fire-resistant plate-like composite material according to claim 28, comprising:
a. Impregnating a sheet comprising woven mineral fibres with a liquid polyfuranyl resin composition; to provide an impregnated sheet;
b. subjecting the impregnated sheet to conditions inducing gelation of the polyfuranyl resin composition, thereby forming a prepreg sheet; and
c. optionally depositing a prepreg sheet onto a transport medium, preferably a backing sheet and optionally removing the prepreg sheet on the backing sheet; and
d. optionally, rolling up the prepreg sheet on the transport medium, to form a reel of a rolled up prepreg sheet; and c1. optionally depositing a prepreg sheet onto a transport medium, preferably a backing sheet and optionally removing the prepreg sheet on the backing sheet;
d1. arranging at least a core layer between two prepreg sheets, such that such that the top surface of the second sheet opposes the bottom surface of the first sheet, to form a sandwich structure; and
e1. subjecting the sandwich structure to conditions that allow the gelled polyfuranyl resin composition to cure essentially fully, preferably including heating the sandwich structure to a temperature and for a time period that results in crosslinking and chain growth of the polyfuranyl resin composition.

40. A prepreg sheet or prepreg sheet reel obtainable from the process according to claim 39.

41. A method for the manufacture of a composite panel according to claim 39, the method comprising:
a. Impregnating a sheet comprising woven mineral fibres with a liquid polyfuranyl resin composition, to provide an impregnated sheet;
b. subjecting the impregnated sheet to conditions inducing gelation of the polyfuranyl resin composition, thereby forming a prepreg sheet according to claim 39;
c. optionally depositing a prepreg sheet onto a transport medium, preferably a backing sheet and optionally removing the prepreg sheet on the backing sheet;
d. arranging at least a core layer between two prepreg sheets, such that such that the top surface of the second sheet opposes the bottom surface of the first sheet, to form a sandwich structure; and
e. subjecting the sandwich structure to conditions that allow the gelled polyfuranyl resin composition to cure essentially fully, preferably including heating the sandwich structure to a temperature and for a time period that results in crosslinking and chain growth of the polyfuranyl resin composition.

42. A method according to claim 41, comprising a further step of applying pressure to the composite panel during curing, wherein the step of applying pressure involves the use of a vacuum table, a plate press, a bag press or a nip rolling apparatus.

43. A method for the manufacture of a composite panel according to claim 42, further adding a further layer of a solid material, preferably a plywood composite material adjacent to a composite prepreg layer prior to step e), to obtain an enforced composite material.

44. A panel element comprising the lightweight fire-resistant plate-like composite material according to claim 28 for a wall or roof of a building, further comprising a vapour-impervious skin and/or a reinforcing layer, for forming a portion of a façade or a roofing, the panel comprising an overhanging portion extending beyond a second edge of each of the panels to secure each of the panels adjacent to one another during installation and to form an air, thermal and moisture barrier between each of the adjacent insulation panels.

45. A panel comprising a core layer formed by the lightweight fire-resistant plate-like composite material according to claim 28, comprising:
a. an integrally formed, outwardly-extending attachment flange defined by the entire thickness of the panel and proximal to the outward surface around two around at least two adjacent side edges of the panel, for receiving elongate fastener elements through the entire thickness of the panel and into an underlying support member;
b. two spaced-apart elements formed on and extending along respective adjacent sides of the attachment flange remote from the surface and defining a groove therebetween;
c. a complementary tongue projecting outwardly from and extending along respective adjacent sides of the panel for being received in a groove of a complementary adjacent structural element;
wherein the attachment flange resides intermediate the groove and the surface, for permitting the groove to receive the tongue of the complementary structural element therein; and optionally, further comprising means for attachment of the panel to an underlying support by fastener elements through the attachment flange.

46. A panel comprising a core layer formed by the lightweight fire-resistant plate-like composite material according to claim 45, wherein first and second alternating interlocking tongues and alternating interlocking grooves comprise dove tail members.

47. A panel comprising a core layer formed by the lightweight fire-resistant plate-like composite material according to claim 46, wherein the panel is essentially rectangular or square shaped.
